(19) United States
(12) Patent Application Publication
(10) Pub. No.: US 2007/0027820 A1
(43) Pub. Date: Feb. 1, 2007

(54) Methods and systems for securing electronic transactions

(76) Inventors: Amir Elharar, Cote-St-Luc (CA); Moshe Hezrony, Cote-St-Luc (CA)

Correspondence Address: NORMAN H. ZIVIN;Cooper & Dunham LLP, 1185 Avenue of the Americas, New York, NY, 10036, US

(21) Appl. No.: 11/191,718

(22) Filed: Jul. 28, 2005

(51) Int. Cl. G06Q 99/00

(52) U.S. Cl. 705/76

(57) ABSTRACT

Methods and systems for securing a prospective electronic transaction between a first party and a second party. The system comprises an authentication entity adapted for generating a transaction indicia for the electronic transaction and sending the transaction indicia to the client computer, wherein receipt of the transaction indicia by a client computer used by the first party causes encryption of the transaction indicia and account information associated with the first party into encrypted data. Also, the system comprises a data center adapted for receiving the encrypted data from the client computer; decrypting the encrypted data to obtain the transaction indicia and the account information associated with the first party; and sending the transaction indicia and the account information to the authentication entity for completion of the electronic transaction on a basis of the account information.

### FIELD OF THE INVENTION

The present invention relates generally to electronic transactions such as commercial transactions and login transactions. More particularly, the present invention relates to methods and systems for securing on-line electronic transactions taking place over a data network such as the Internet.

### BACKGROUND

Electronic commerce is a process by which consumers effect transactions with merchants over the Internet, i.e., where one's physical presence at a point of sale is substituted by electronically supplying account information or other relevant financial data. The advantage of electronic commerce from the consumer's point of view is the ability to choose from an abundance of products and merchants on the Internet, which tends to result in lower prices. As far as merchants are concerned, the advantage of electronic commerce is the ability to sell goods and services without maintaining a network of retailers, hence resulting in reduced labor and real estate costs.

Many electronic transactions are paid for by a credit account associated with a credit card issued by a credit card company in the consumer's name. Specifically, consumers wishing to make a transaction electronically supply information about the credit account to the merchant, who then issues a request to the credit card company for authorizing the transaction. Thus, the physical presence of the credit card is inconsequential; rather, it is the account information associated with the credit card (i.e., the credit account information) that renders the transaction possible. While this is a simple scheme, it has a tremendous flaw from a security standpoint. Specifically, because all the information necessary to complete a transaction is being divulged over the Internet, this information may be intercepted (i.e., stolen) and used for illicit purposes. This is known as online fraud.

Online fraud costs merchants, consumers and especially credit card companies billions of dollars annually. In addition, there may be long-term repercussions on consumers whose financial information has been stolen. In order to combat online fraud, credit card companies have invested in implementing techniques to detect fraudulent transactions by using, for example, address verification service (AVS), card verification number (CVN), customer history, geolocation, public records databases, etc. However, not only do these techniques fail to capture all fraudulent transactions, but for each successful detection of a fraudulent transaction, it has been found that an equal number (or more) of legitimate transactions are rejected because they present symptoms—albeit false ones—of being fraudulent.

Another method of combatting fraud is to simply encrypt the credit account information that is exchanged over the Internet between the consumer and the merchant. Typically, encryption software (e.g., in the form of a downloadable plug-in) is used for this purpose. However, this will not be a workable solution if the encryption software is not trusted by the credit card company (and/or the consumer). Moreover, such systems are prey for hackers on the Internet, who will attempt to break into the merchant's server behind the encryption software and thus illicitly obtain a large number of credit card numbers.

Thus, it is clear that the industry would welcome improved methods and systems for securing electronic transactions.

### SUMMARY OF THE INVENTION

In accordance with a first broad aspect, the present invention may be summarized as a method of securing a prospective electronic transaction between a first party and a second party. The method comprises generating a transaction indicia for the electronic transaction and sending the transaction indicia to the client computer, wherein receipt of the transaction indicia by a client computer used by the first party causes encryption of the transaction indicia and account information associated with the first party into encrypted data. Then, responsive to receipt of the transaction indicia and the account information from a data center to which the client computer has communicated the encrypted data, the electronic transaction is completed on a basis of the account information.

In accordance with a second broad aspect, the present invention may be summarized as a method of securing a prospective electronic transaction between a first party and a second party. The method comprises receiving encrypted data from a client computer used by the first computer, the encrypted data comprising (I) an encrypted version of a transaction indicia obtained by the client computer from an authentication entity and (II) an encrypted version of account information associated with the first party obtained from a portable memory device communicatively coupled to the client computer. The method also comprises decrypting the encrypted data using decryption parameters to obtain the transaction indicia and the account information and sending the transaction indicia and the account information to the authentication entity for completion of the electronic transaction on a basis of the account information.

In accordance with a third broad aspect, the present invention may be summarized as a system for securing a prospective electronic transaction between a first party and a second party. The system comprises an authentication entity adapted -for generating a transaction indicia for the electronic transaction and sending the transaction indicia to the client computer, wherein receipt of the transaction indicia by a client computer used by the first party causes encryption of the transaction indicia and account information associated with the first party into encrypted data. Also, the system comprises a data center adapted for receiving the encrypted data from the client computer; decrypting the encrypted data to obtain the transaction indicia and the account information associated with the first party; and sending the transaction indicia and the account information to the authentication entity for completion of the electronic transaction on a basis of the account information.

In accordance with a fourth broad aspect, the present invention may be summarized as a portable memory device for facilitating on-line transactions performed via a computer running a browser. The portable memory device comprises a data storage medium for holding data indicative of account information and a communication interface for allowing said portable memory device to establish a temporary data communication pathway with the computer to supply via the data communication pathway the account information for use by the browser in effecting an on-line transaction.

In accordance with a fifth broad aspect, the present invention may be summarized as a device for securing electronic transactions between a first party and a second party. The device comprises an input/output interface for interfacing with a client computer used by the first party; a memory storing at least one account information record for the first party, each of the account information record storing account information and being accessible by a respective identifier; and a processing unit having encryption functionality and adapted to interact with a browser executing on the client computer. The processing unit is responsive to receipt of a particular identifier to encrypt the account information in the account information record corresponding to the particular identifier into encrypted data and provide the encrypted data to the client computer via the input/output interface.

In accordance with a sixth broad aspect, the present invention may be summarized as computer-readable media tangibly embodying an application program executable by a client computer to perform a method of securing electronic transactions between the client computer and a server. The application program comprises computer-readable program code means for being attentive to receipt of an identification of a desired account to be used in an electronic transaction; computer-readable program code means for signaling to the server a desire to effect the electronic transaction; computer-readable program code means for being attentive to receipt from an authentication entity of a transaction indicia for the electronic transaction; computer-readable program code means for supplying the transaction indicia and the identification of the desired account to a device communicatively coupled with the client computer; computer-readable program code means for being attentive to receipt from the device of an information packet comprising an encrypted version of the transaction indicia and an encrypted version of account information associated with the desired account; and computer-readable program code means for releasing the information packet to a data center capable of decrypting the information packet and forwarding the transaction indicia and the account information to the authentication entity for completion of the electronic transaction.

### BRIEF DESCRIPTION OF THE DRAWINGS

These and other aspects and features of the present invention will now become apparent to those of ordinary skill in the art upon review of the following description of specific embodiments of the invention in conjunction with the accompanying drawings.

In the accompanying drawings:

FIG. 1 depicts in block diagram form a first party transacting with a second party, the first party being equipped with a securekey in accordance with an embodiment of the present invention;

FIG. 2 illustrates a possible arrangement of a portion of a memory in the securekey;

FIGS. 3A and 3B depict in block diagram form the second party, a data center and two respective configurations of an authentication entity, in accordance with embodiments of the present invention;

FIGS. 4A to 4D show steps in a process of securing an electronic transaction effected between the first party and the second party, in accordance with an embodiment of the present invention, in which the transaction is a commercial transaction;

FIG. 5 shows steps in a process of securing an electronic transaction effected between the first party and the second party, in accordance with a first enhanced-security variant of the embodiment of FIGS. 4A to 4D;

FIG. 6 shows steps in a process of securing an electronic transaction effected between the first party and the second party, in accordance with a second enhanced-security variant of the embodiment of FIGS. 4A to 4D;

FIG. 7 illustrates a possible arrangement of a portion of a memory in the securekey, in accordance with another embodiment of the present invention;

FIGS. 8A and 8B depict in block diagram form the second party and a data center connected to an authentication entity, in accordance with two possible arrangements;

FIG. 9 show some initial steps in a process of securing an electronic transaction effected between the first party and the second party, in accordance with another embodiment of the present invention, in which the transaction is a login transaction;

FIG. 10 shows a continuation of the process in FIG. 9 if the transaction does not require encryption by the securekey;

FIGS. 11A-11C show a continuation of the process in FIG. 9 if the transaction does require encryption by the securekey.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

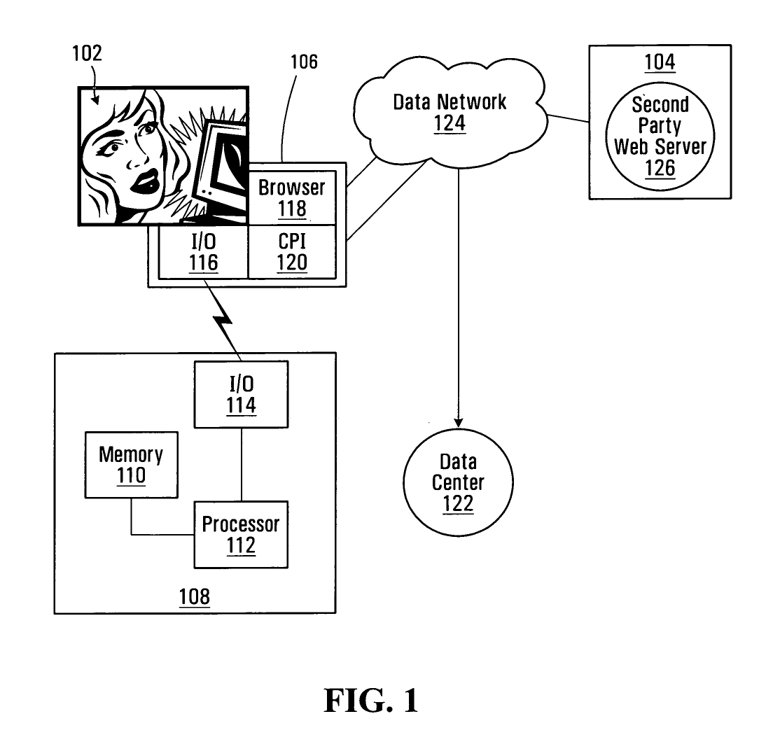

FIG. 1 depicts a first party 102 that may wish to effect electronic transactions with a second party 104 using a computer 106 connected to the second party over a data network 124 such as a public data network (e.g., the Internet). By “electronic transaction”, which is sometimes used interchangeably with “on-line transaction”, it is meant an act between the first party's computer 106 and a server 126 associated with the second party 104 that exchanges one item of value for another. One non-limiting type of electronic transaction is a commercial transaction and another non-limiting type of electronic transaction is a login transaction. The server 126 is typically operated by the second party but may in certain cases be operated by a third party while remaining associated with the second party 104.

In a “commercial transaction”, the first party 102 provides payment (or, in the case of a credit account transaction, a promise of payment by a third party) in exchange for goods or services supplied by the second party 104. In a “login transaction”, the first party 102 provides credentials (e.g., username and password) in exchange for access to an account (e.g., an email account) hosted by the second party 104. Still other types of transactions will be apparent to those of ordinary skill in the art.

“Securekey” Hardware

In accordance with specific embodiments of the present invention, the first party 102 is provided with a “securekey” 108, which is a portable device that communicates with the first party's computer 106. The securekey 108 contains a memory 110, a processor 112 and an input/output (I/O) interface 114. The securekey input/output interface 114 can be electrical (e.g., USB connector, serial port, etc.) or it may be contact-less (e.g., RFID, optical, infra-red, etc.). The securekey 108 can be made portable and, indeed, handheld or suitable for being manipulated by one or several fingers.

The securekey memory 110 stores data pertaining to the first party 102. As will be described in greater detail herein below, the data pertaining to the fist party 102 reflects the types of transactions that can be effected securely by the first party 102. In addition, the securekey memory 110 contains a serial number of the securekey 108 or a similar data element that allows unique identification of the securekey 108, hereinafter referred to as a “key ID”.

The data pertaining to the first party 102, as stored in the securekey memory 110, may be subject to restrictions on access by an external requester. In a non-limiting example, a data element (not shown) stored in the securekey memory 110 stores a password, which is required to accompany any external request for the contents of the securekey memory 110 before such contents can be released to the requestor. In another embodiment, the data element can correspond to biometric code or image as derived from a fingerprint, retina scan, etc. In such an embodiment, a fingerprint reader, retina scanner, etc. may be integrated with (or otherwise connected to) the securekey 108, thereby to enable capture of the requestor's biometric feature.

The securekey processor 112 can be implemented as a processing unit, such as a microcontroller, for example. The securekey processor 112 has suitable software, hardware and/or control logic to implement an encryption algorithm using encryption parameters that may also be stored in the securekey memory 110 (to be described in greater detail below). The encryption algorithm and the encryption parameters are not known by the second party 104, but are known by a data center 122 where the securekey 108 is registered. The data center 122 is reachable via the data network 124.

The first party's computer 106 is equipped with a corresponding input/output interface 116 for communicative coupling with the securekey 108. In addition, the first party's computer 106 runs a browser 118 which facilitates navigation over the data network 124. The browser 118 is equipped with a client plug-in (CPI) 120 which gives the first party's computer 106 the capability of communicating with the securekey 108 via the input/output interface 116. In addition, the CPI 120 is adapted to redirect the browser 118 to communicate with the data center 122 when appropriate.

The functionality of the securekey 108 and the CPI 120 will become apparent from the following description of two non-limiting example transactions, the first being a commercial transaction and the second being a login transaction.

Commercial Transaction

In the case of a commercial transaction, the first party 102 can be referred to as a “consumer” and the second party can be referred to as a “merchant”. In the specific example to be discussed below, the commercial transaction is a credit account transaction, which suggests that the transaction involves a promise of payment by a third party (and may be effected without the existence of a physical credit card). In general, however, it will be appreciated that the commercial transaction may be a debit account transaction or any other type of financial transaction.

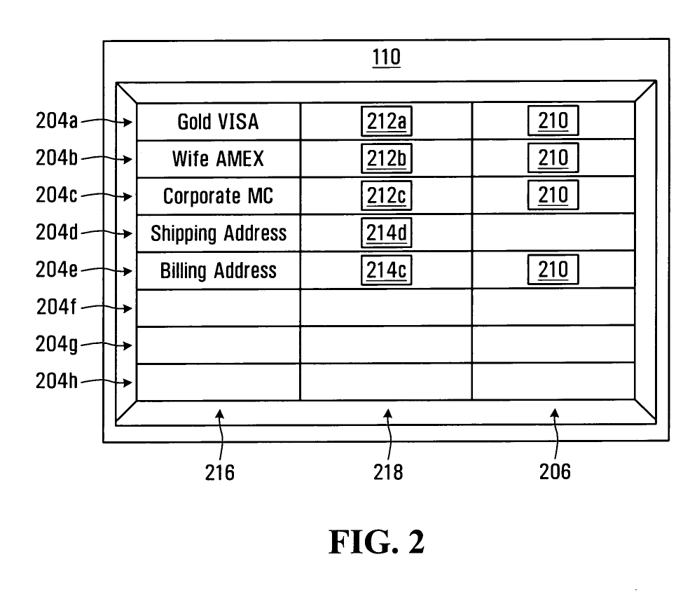

Further detail regarding the contents of the securekey memory 110 in the context of a credit account transaction is provided in the conceptual diagram of FIG. 2. Specifically, in this non-limiting example, a portion of the securekey memory 110 stores information regarding credit accounts and information regarding personal characteristics. This information can be visualized as a database of records 204a, . . . , 204h, with each record pertaining to either a credit account or a personal characteristic. In a particular configuration, each of the records 204a, . . . , 204h includes a “nickname” field 216 and a data field 218.

The contents of the nickname field 216 for a particular record is used to descriptively identify the record in question in a format that is convenient for the consumer 102. The contents of the nickname field 216 for a particular record includes a credit account nickname or a personal characteristic nickname, depending on the data stored in the data field 218. Illustrative but of course non-limiting examples of credit account nicknames include “gold VISA”, “wife AMEX”, “corporate MC”, which are meant to represent individual Visa, American Express and MasterCard credit accounts, respectively, while illustrative but non-limiting examples of personal characteristic nicknames include “shipping ad” and “billing ad”, which are meant to represent individual addresses for shipping and billing purposes, respectively.

The data field 218 for a particular record contains information regarding the record in question, in a format that is useful to the merchant 104 and/or the credit card company. The contents of the data field 218 for a particular record identified by a credit account nickname (in the present example, records 204a, 204b and 204c fall into this category) includes credit account information, in this case denoted 212a, 212b and 212c, respectively. For example, the credit account information for a record identified by the credit account nickname “gold VISA” may include the digits that would be required for processing an electronic transaction using the particular VISA credit account.

Similarly, the contents of the data field 218 for a particular record identified by a personal characteristic nickname (in the present example, records 204d and 204e fall into this category) includes personal characteristic information, in this case denoted 214d and 214e, respectively. For example, the personal characteristic information for a record identified by the personal characteristic nickname “shipping ad” may include an address for shipping purposes.

Both types of records (i.e., those pertaining to a credit account and those pertaining to a personal characteristic) may be subject to security restrictions on output format. In a non-limiting example, which applies in this case to records 214a, 214b, 214c and 214e, a data element stored in the respective record contains encryption parameters 210. As will be seen in greater detail below, the encryption parameters 210 can be used to encrypt the contents of the respective data field 218 before such contents are released by the securekey 108 via the input/output interface 114.

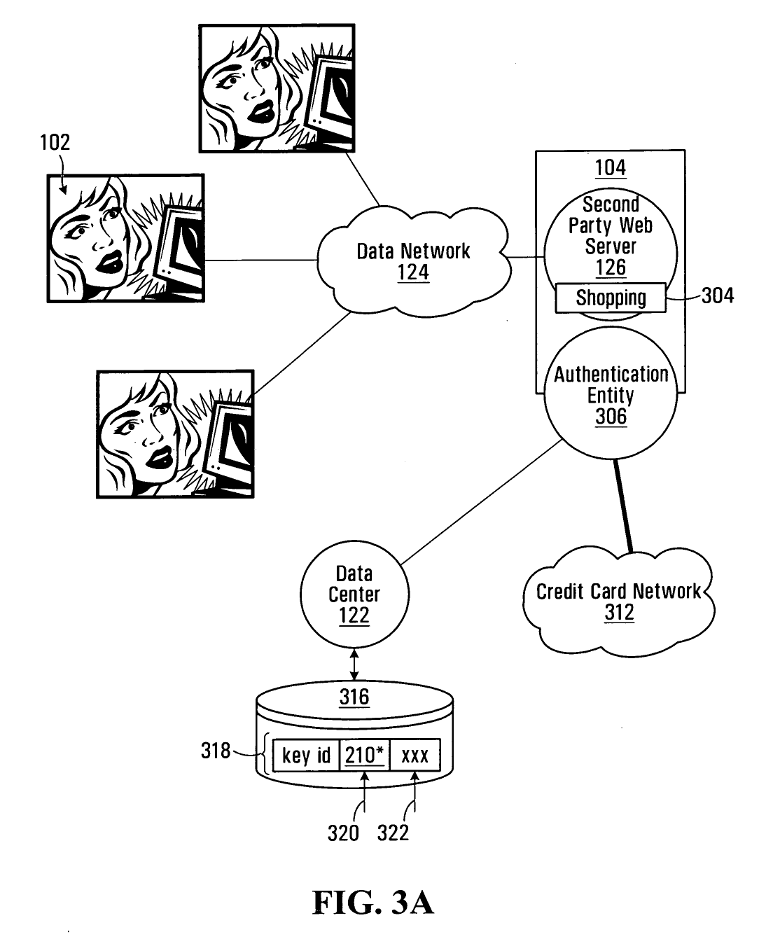

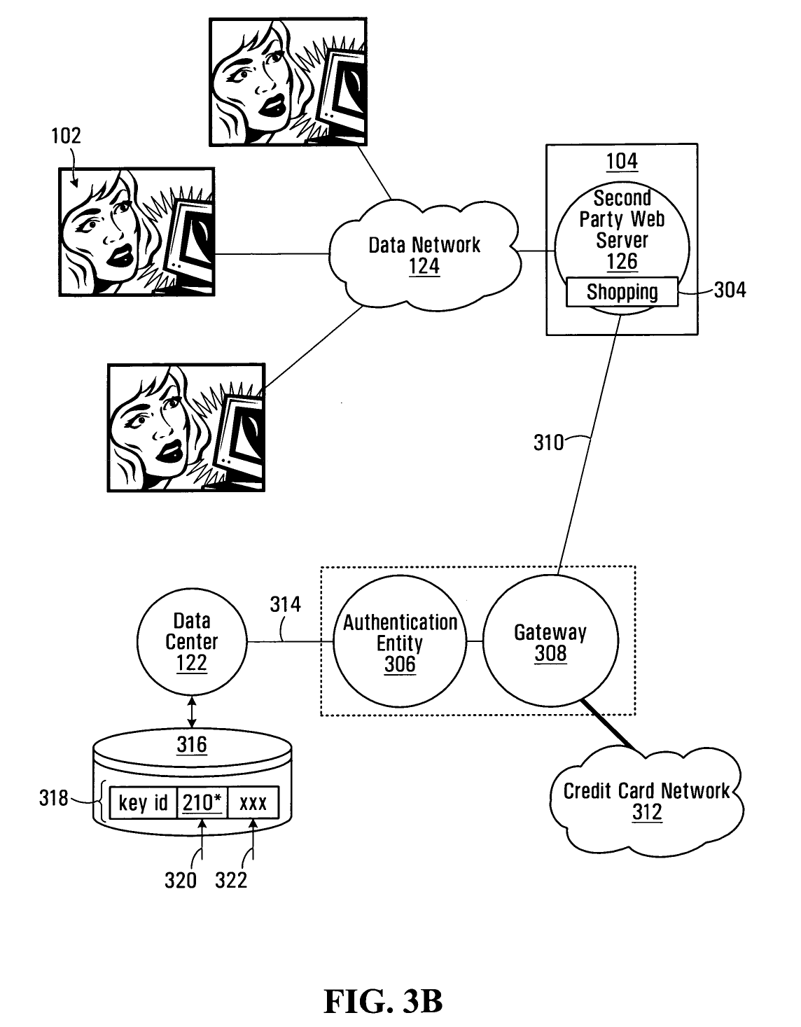

Turning now to FIGS. 3A and 3B, there is shown a merchant 104 that provides electronic commerce facilities to the consumer 102 as well as other consumers over the data network 124. For example, the merchant 104 may operate a web server 126 that runs a shopping application 304 which interacts with the browser 118 running on the consumer's computer 106. When the consumer 102 is ready to purchase an item, the shopping application 304 provides a “secure checkout” option to the consumer 102 via the browser 118, possibly in addition to a standard checkout option. The provision of a secure checkout option is relatively straightforward and may be implemented as a modification to existing shopping application software.

In order to authenticate electronic transactions further to the consumer 102 selecting the secure checkout option, and as will be described in further detail herein below, the web server 126 of the merchant 104 communicates with an authentication entity 306. For “larger” merchants (FIG. 3A), the authentication entity 306 may be part of the merchant's infrastructure, which comprises the web server 126 and possibly other equipment. For “smaller” merchants (FIG. 3B), the authentication entity 306 may be a separate entity that is connected to a third-party gateway 308 to which the merchant 104 connects via a secure or unsecure link 310, possibly via the data network 124. Since what is being described here is a credit account transaction, the authentication entity 306 (in FIG. 3A) or the gateway 308 (in FIG. 3B) is connected to one or more credit card companies via a credit card network 312, which is assumed to be secure.

The authentication entity 306 is connected to the data center 122 by a link 314 that is considered secure (e.g., virtual private network, quantum cryptographic channel, etc.). The data center 122 maintains information regarding the various securekeys (including securekey 108 belonging to consumer 102) and, by extension, the various consumers. Specifically, the data center 122 maintains a database 316 of records 318, where each record 318 corresponds to a different securekey and is indexed by the corresponding securekey's key ID.

Specifically, the record 318 corresponding to the securekey 108 comprises a field 320 which contains decryption parameters 210* that are needed to decrypt information encrypted by the securekey 108 using the aforementioned encryption parameters 210. In addition, the record 318 corresponding to the securekey 108 may comprise another field 322 which contains some or all of the credit account information and personal characteristic information for the consumer 102 associated with the securekey 108. This may be advantageous in case the securekey 108 is lost or damaged, and a new one needs to be sent to the consumer 102.

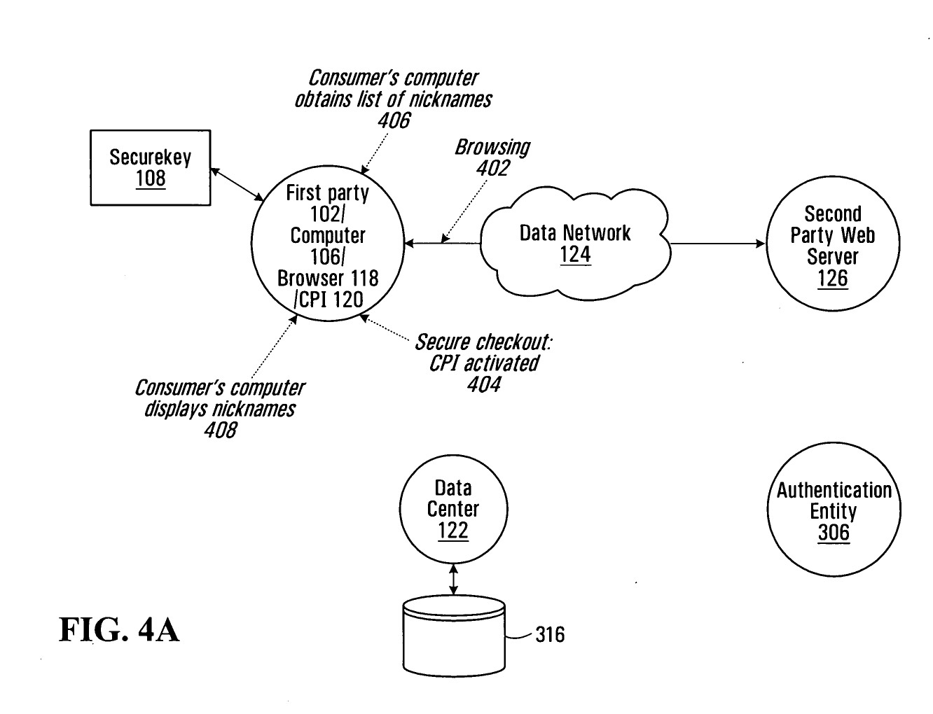

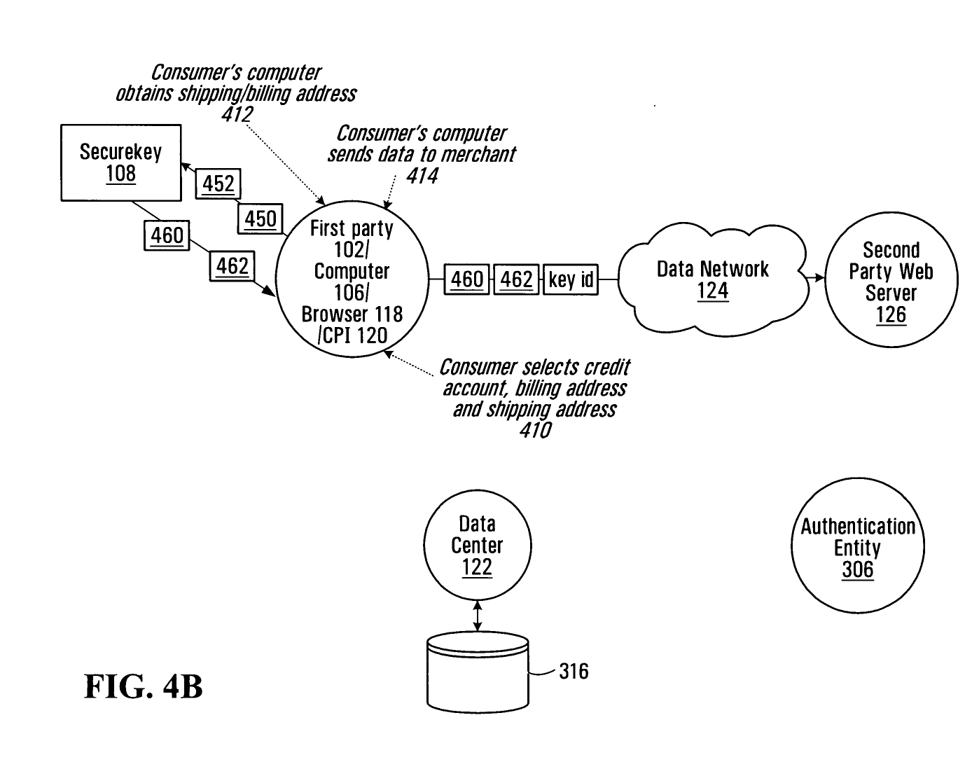

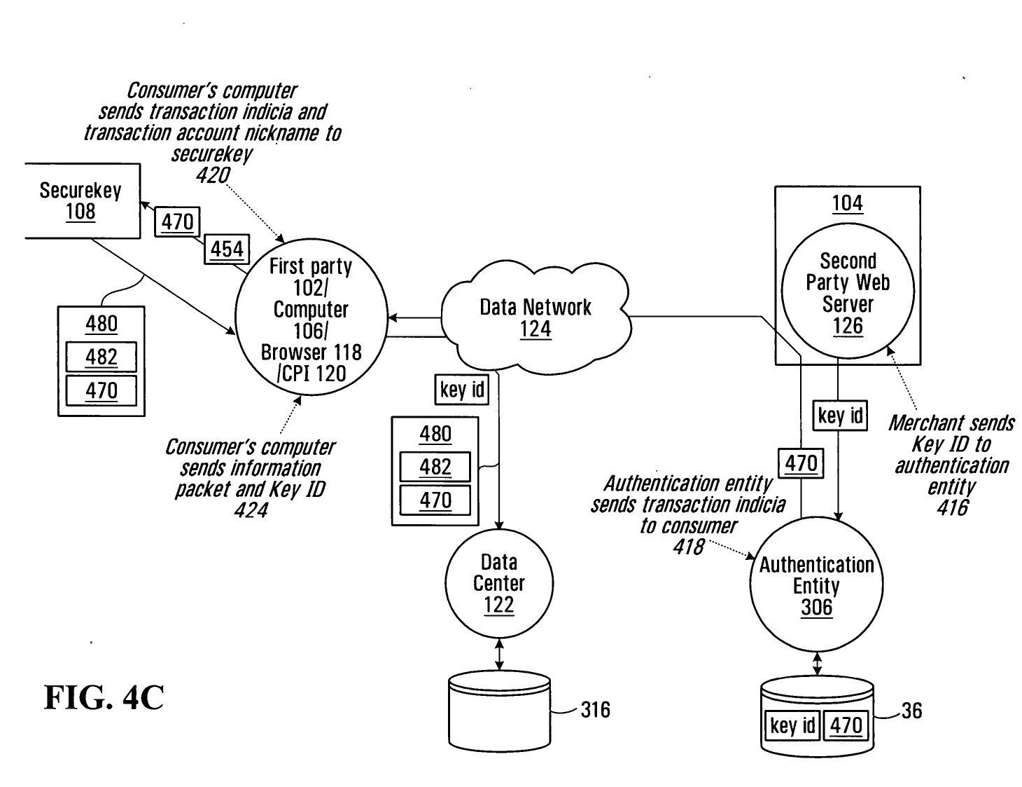

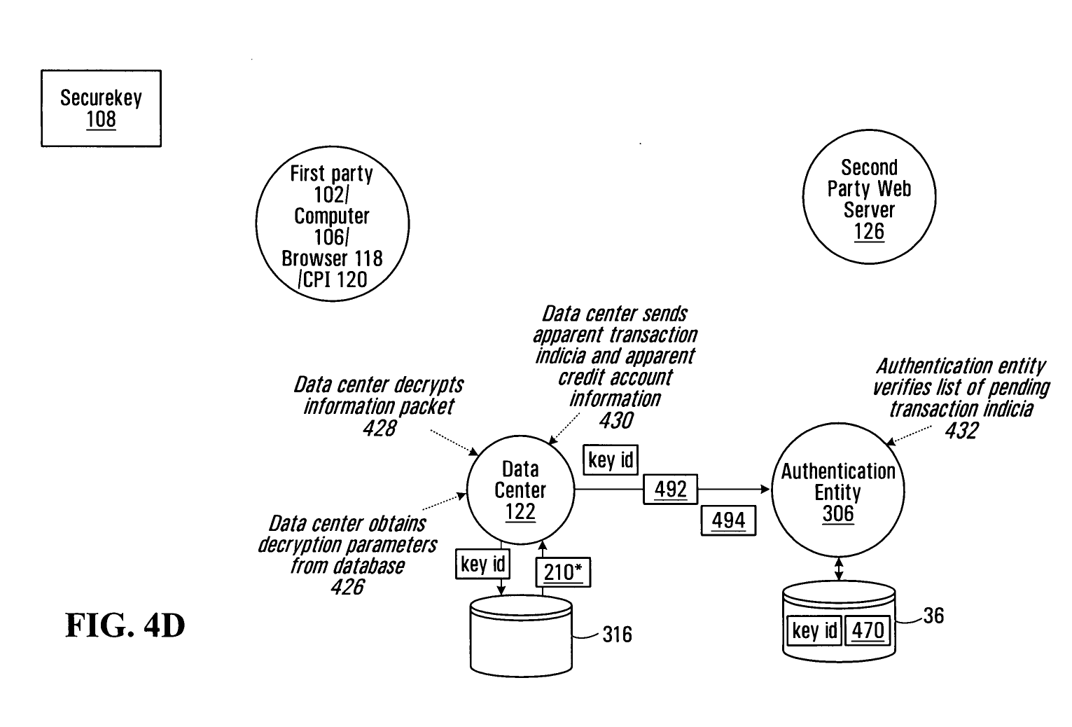

Various steps in an example process for securing a transaction are now described with reference to FIGS. 4A-4D wherein, at step 402, the consumer 102 uses the browser 118 on the consumer's computer 106 to interact with the shopping application 304 running on the merchant's web server 126. It is recalled that the browser 118 is equipped with the aforementioned client plug-in (CPI) 120 which gives the browser 118 additional functionality. For the purposes of illustration, it is also assumed that the consumer 102 is “legitimate”, i.e., is connected to the previously described securekey 108, which is presumed to be registered with the data center 122.

At step 404, the consumer 102 decides to effect an electronic transaction and chooses the secure checkout option described above. As the transaction has not yet actually been completed, it can be referred to as a prospective transaction. Selection of the secure checkout option activates the CPI 120, which has the following effect. Specifically, at step 406, the CPI 120 queries the securekey 108 to obtain the list of nicknames (i.e., the contents of the nickname field 216 of each record 204a, . . . , 204h) stored in the securekey memory 110.

As previously mentioned, access to the contents of the securekey memory 110 may be restricted, and for example a password may need to be entered by the consumer 102 in order for such contents (in this case, the list of nicknames) to be released. Assuming that the password is provided or the security restriction otherwise overcome, the CPI 120 obtains the set of credit account nicknames and personal characteristic nicknames contained in the nickname field 216 of the various records 204a, . . . , 204h in the securekey memory 110. At step 408, the CPI 120 renders the nicknames available for selection by the consumer 102, e.g., by displaying them on a monitor.

At step 410, the consumer 102 selects one of the credit account nicknames corresponding to a credit account that the consumer 102 wishes to use for the current prospective transaction. The selected credit account nickname will hereinafter be referred to as the “transaction account nickname” (denoted 454 although not shown until FIG. 4C). In addition, the consumer 102 may select one or more personal characteristic nicknames, depending on the application. For example, this may include selection of a first personal characteristic nickname for shipping purposes (hereinafter referred to as a “shipping address nickname” 450) and a second personal characteristic nickname for billing purposes (hereinafter referred to as a “billing address nickname” 452). The computer 106 provides the shipping address nickname 450 and the billing address nickname 452 to the securekey 108 via the input/output interface 116. Noting, however, that the record identified by the transaction account nickname 454 is associated with the encryption parameters 210, the computer 106 does not submit the transaction account nickname 454 to the securekey 108, but rather retains it for later use.

At step 412, the contents of the data field 218 of the record identified by the shipping address nickname 450 (which is hereinafter referred to as the shipping address data 460) and possibly also the contents of the data field 218 of the record identified by the billing address nickname 454 (hereinafter referred to as the billing address data 462) are returned by the securekey 108. At step 414, the shipping address data 460 and the billing address data 462 are bundled together with the key ID of the securekey 108 (which is learned by the CPI 120 through its connection to the securekey 108). These items of information are forwarded by the consumer's computer 106 to the web server 126 over the data network 124.

In accordance with embodiments of the present invention, the authentication entity 306 authenticates the prospective transaction. For the purposes of the present example, but without limitation, it is assumed that the merchant 104 is a “smaller” merchant, i.e., the authentication entity 306 is accessed via the third-party gateway 308. At step 416, the web server 126 retains the shipping address data 460 and the billing address data 462, while forwarding the key ID to the authentication entity 306 (via the gateway 308 if appropriate).

Through receipt of the key ID, the authentication entity 306 learns that there is a consumer, in this case the consumer 102, who is effecting a prospective transaction and is claiming to be using a securekey, in this case the securekey 108 identified by the key ID. Since the authenticity of the consumer 102 is not yet known to the authentication entity 306, authentication of the consumer 102 is undertaken. To authenticate the consumer 102, the authentication entity 306 engages the consumer's securekey 108 in a test by providing test data to the consumer's computer 106. This test data is hereinafter referred to as “transaction indicia” 470, which is associated with the key ID and stored in a list or database 36 at the authentication entity 306. Accordingly, at step 418, the authentication entity 306 sends the transaction indicia 470 to the consumer's computer 106 via the data network 124. In a non-limiting example, the transaction indicia 470 is an alphanumeric code.

At step 420, the CPI 120 running on the consumer's computer 106 sends the transaction indicia 470 as well as the previously retained transaction account nickname 454 to the securekey 108. The securekey 108 locates the credit account information in the data field 218 of the record identified by the transaction account nickname 454. This credit account information is denoted by the reference numeral 482. In addition, the securekey 108 determines that there is a requirement to encrypt the credit account information 482 using the encryption parameters 210 before releasing it to the requestor (viz., the CPI 120). Accordingly, at step 422, the securekey 108 uses the encryption parameters 210 to encrypt both the credit account information 482 and the transaction indicia 470. The encrypted credit account information and encrypted transaction indicia are placed together in an information packet 480.

As previously mentioned, the parameters 210 used for encryption are stored within the securekey 108 and, although known to the data center 122, they are not publicly available to other entities. It should be understood that different encryption parameters 210 may apply to different credit accounts. Also, the encryption parameters 210 may be static or, as in certain other embodiments to be described later on in this specification, the encryption parameters 210 may change over time, in a manner that is either known or controlled by the data center 122. In a simple non-limiting example, the encryption parameters 210 specify a symmetric key, i.e., the decryption parameters 210* are identical to the encryption parameters 210. However, any encryption scheme can be used, including but not limited to asymmetric encryption.

At step 424, the information packet 480 received from the securekey 108 is bundled with the key ID (which is not encrypted using the encryption parameters 210) and sent by the consumer's computer 106 to the data center 122 via the data network 124. The data center 122 receives the information packet 480 and the key ID over the data network 124 and uses the key ID as an index into the database 316 in order to identify a corresponding one of the records 318 that is indexed by the received key ID (i.e., the key ID of the securekey 108). At step 426, the data center 122 identifies the decryption parameters 210* contained in the corresponding one of the records 318. It is recalled that if the encryption process is symmetric, then the decryption parameters 210* will be identical to the encryption parameters 210.

At step 428, the data center 122 attempts decryption of the information packet 480 using the decryption parameters 210* found in the database 316. In the case where a legitimate securekey 108 was employed, decryption of the information packet 480 will be successful and the result of the decryption will be the transaction indicia 470 and credit account information (which is the credit account information corresponding to the transaction account nickname 454). Generally speaking, it is not known a priori whether a legitimate securekey is being used and therefore the result of the decryption will be data (denoted 492) that only appears to specify a transaction indicia and data (denoted 494) that only appears to specify credit account information. Further authentication is thus required.

Accordingly, at step 430, the data center 122 forwards the key ID, as well as the data 492 that appears to specify a transaction indicia and the data 494 that appears to specify credit account information to the authentication entity 306 via the link 314, which is considered secure. At step 432, the authentication entity 306 verifies its database 36 of pending transaction indicia (and associated key IDs) to see whether any of the pending transaction indicia is associated with the received key ID. In the present example, the transaction indicia 470 was indeed pending and therefore if the data 492 that appears to specify a transaction indicia does correspond to the transaction indicia 470, then authenticity of the prospective transaction will have been confirmed. In other words, it will have been confirmed that the data 494, which heretofore only appeared to specify credit account information, does indeed specify credit account information for a credit account that the consumer 102 genuinely wishes to use for the current prospective transaction. It is recalled that in the present example, this credit account information was referred to by the reference numeral 482.

With authentication of the prospective transaction having been successful, either the gateway 308 (in the case of a smaller merchant) or the merchant 104 itself (in the case of a larger merchant) forwards the data 494 (which, in the present example, is the same as the credit account information 482) to the credit card company over the credit card network 312. The credit card company is then of course free to apply its own fraud detection methodologies before authorizing the prospective transaction and making it an actual transaction.

However, if the data 492 that appeared to specify a transaction indicia does not correspond to the transaction indicia 470 or any other pending transaction indicia for the securekey corresponding to the key ID, then the prospective transaction will not have been successfully authenticated. In this case, action can be taken by the authentication entity 306, such as signaling to the merchant 104 (or to the gateway 308 or to the credit card company, etc.) that the prospective transaction may be fraudulent.

Enhanced-Security Variant 1: Dynamic Encryption Parameters

As alluded to earlier, the encryption parameters 210 and the decryption parameters 210* need not be static but rather can change in a manner that is either known or controlled by the data center 122. This may be advantageous from the point of view of providing enhanced security, as an intercepting party is not likely to be able to predict the manner in which the encryption parameters 210 and particularly the decryption parameters 210* change over time.

Specifically, consider the case where the encryption algorithm being executed by the securekey processor 112 and the decryption algorithm being executed by the data center 122 utilize a complementary pair of keys, that is to say, the encryption parameters 210 include an encryption key and the decryption parameters 210* include a decryption key. (Where the same key is used for both encryption and decryption, this is known as a symmetric encryption scheme.) In accordance with an embodiment of the present invention, the encryption key is varied over time, as can be done in a non-limiting example embodiment by implementing identical pseudo-random number generators in the securekey processor 112 and in the data center 122. The two pseudo-random number generators are initiated using the same seed. With each transaction involving the securekey 108, the pseudo-random number generators are advanced to their next state. Because the same seed was used to initiate both pseudo-random number generators, the result (i.e., the encryption key) will be replicated in both the securekey 108 and the data center 122. Where the encryption scheme is symmetric, the data center 122, by generating a new encryption key, instantly has access to the correct decryption key. Where the encryption scheme is not symmetric, the data center 122 can perform a more complex algorithm to derive the decryption key for each encryption key generated in the above manner.

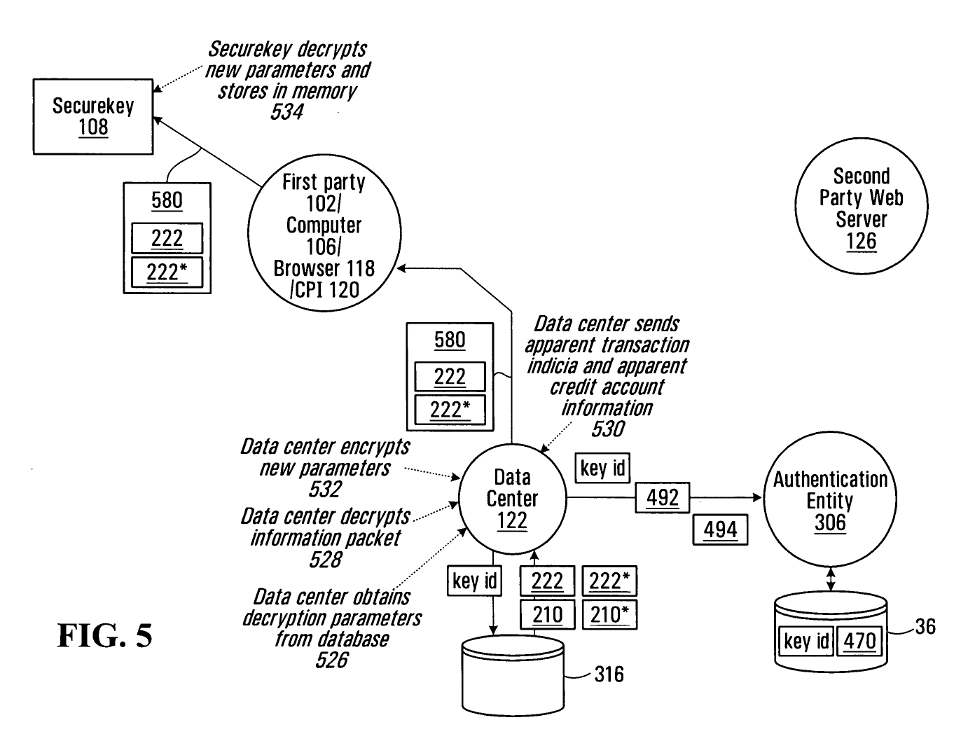

As an alternative to the technique of using parallel pseudo-random number generators in both the securekey 108 and the data center 122, the data center 122 can supply the securekey 108 with new encryption parameters 210 on a transaction-by-transaction basis. This is now described with reference to FIGS. 5.

In this embodiment, the analogue to the aforementioned database 316 in the data center 122 is denoted by the reference numeral 316*. The database 316* comprises a set of records 318*, where each record corresponds to a different securekey and is indexed by the corresponding securekey's key ID. The record 318* corresponding to the securekey 108 comprises the aforementioned field 320, which contains the decryption parameters 210* that are needed to decrypt information encrypted by the securekey 108 using the encryption parameters 210. It is recalled that in this embodiment, the encryption parameters 210 (and decryption parameters 210*) are valid only for the current prospective transaction and hence are referred to as current encryption parameters (and current decryption parameters 210*).

In addition, where in FIGS. 4A-4D the database 316, strictly speaking, did not require knowledge of the encryption parameters 210, the database 316* does store this information. Specifically, this information can be stored in the aforementioned field 320. Additionally, the record 318* corresponding to the securekey 108 comprises a second field 324 which contains “new” encryption parameters 222 that are to be used by the securekey 108 to encrypt data for the next prospective transaction, as well as the corresponding “new” decryption parameters 222*.

As for the securekey 108, the current encryption parameters 210 are stored as before in the securekey memory 110, which also allocates memory for storing the current decryption parameters 210* (which were not, strictly speaking, required in the embodiment of FIGS. 4A-4D), in addition to the new encryption parameters 222 and the associated new decryption parameters 222* that will eventually be received from the data center 122.

Beginning now with step 526 in FIG. 5, which is analogous to step 426 in FIG. 4D, the data center 122 consults the database 316* and identifies the current decryption parameters 210* contained in the corresponding one of the records 318* indexed by the received key ID. In addition, the data center 122 obtains the new encryption parameters 222 and new decryption parameters 222* for future use by the securekey 108.

At step 528, the data center 122 attempts decryption of the information packet 480 using the current decryption parameters 210 found in the database 316*. In the case where a legitimate securekey 108 was employed, decryption of the information packet 480 will be successful and the result of the decryption will be the transaction indicia 470 and credit account information (which is the credit account information corresponding to the transaction account nickname 454). Generally speaking, it is not known a priori whether a legitimate securekey is being used and therefore the result of the decryption will be data (denoted 492) that only appears to specify a transaction indicia and data (denoted 494) that only appears to specify credit account information. Further authentication is thus required.

Accordingly, at step 530, the data center 122 forwards the key ID, as well as the data 492 that appears to specify a transaction indicia and the data 494 that appears to specify credit account information to the authentication entity 306 via the link 314. The remainder of the authentication process performed at the authentication entity 306 is the same as was previously described with reference to FIG. 4D.

Meanwhile, at step 532, the data center 122 encrypts the new encryption parameters 222 and the new decryption parameters 222* into a return information packet 580 that is forwarded to the securekey 108 over the data network 124 (and through the consumer's computer 106). Encryption of the information in the return information packet 580 is performed using the current encryption parameters 210 which, as described above, may be stored in the field 320 of the record 318* corresponding to the securekey 108.

At step 534, performed at the securekey 108, the return information packet 580 is decrypted by the securekey 108 using the current decryption parameters 210*. As a result of decryption of the information packet 580, the securekey 108 obtains the new encryption parameters 222 and the new decryption parameters 222*. Still as part of step 534, the securekey 108 causes the current encryption parameters 210 and the current decryption parameters 210* to be replaced with the recently received new encryption parameters 222 and new decryption parameters 222*, respectively, in the securekey memory 110.

The above embodiment was described with sufficient generality to illustrate usage of any type of encryption scheme, whether asymmetric or symmetric. Of course, implementation of the above described embodiment may be simplified if the encryption scheme is symmetric.

Enhanced-Security Variant 2: Confirmation of Transaction

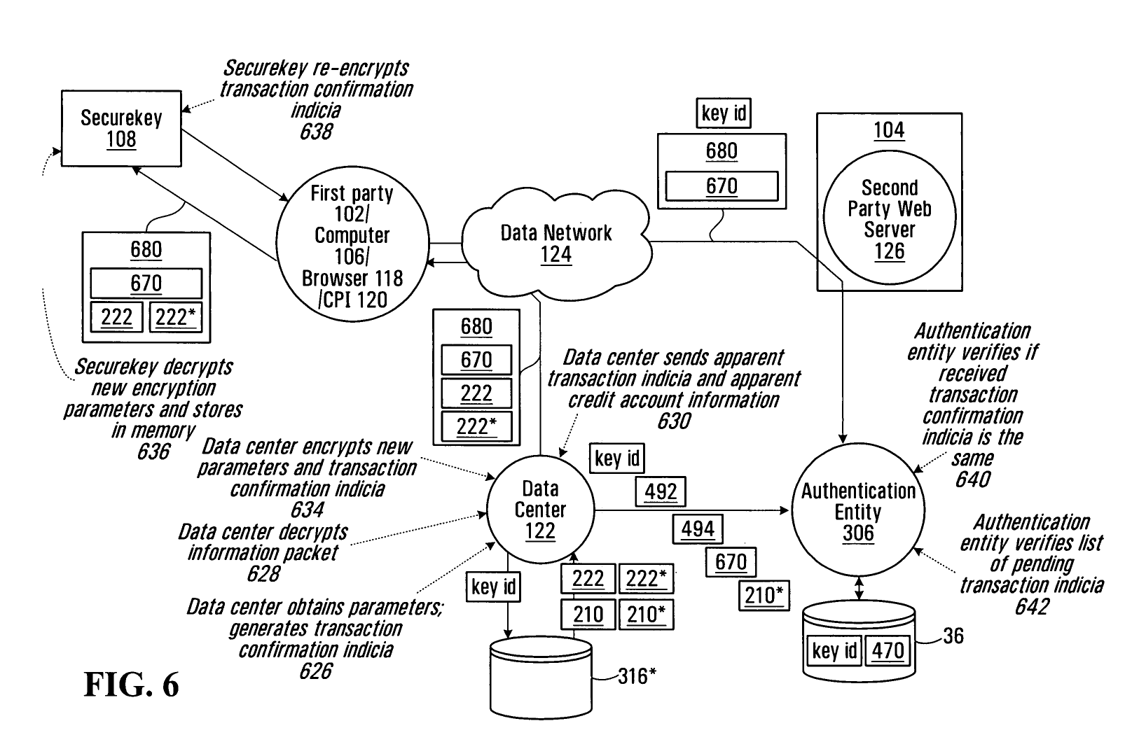

To provide an added layer of security, the data center 122 can be adapted to send, for each authenticated prospective transaction, a transaction confirmation indicia to the securekey 108, for eventual transmission to the authentication entity 306 via the merchant 104. One non-limiting way in which this can be achieved is now described with reference to FIG. 6, which builds upon the embodiment immediately above.

Specifically, at step 626, which is analogous to step 526 in FIG. 5, the data center 122 consults the database 316* and identifies the current decryption parameters 210* contained in the corresponding one of the records 318* indexed by the received key ID. In addition, the data center 122 obtains the new encryption parameters 222 and the new decryption parameters 222* for future use by the securekey 108. Furthermore, the data center 122 generates a transaction confirmation indicia 670, which may or may not be stored in the database 316*.

At step 628, the data center 122 attempts decryption of the information packet 480 using the current encryption parameters 210 found in the database 316*. In the case where a legitimate securekey 108 was employed, decryption of the information packet 480 will be successful and the result of the decryption will be the transaction indicia 470 and credit account information (which is the credit account information corresponding to the transaction account nickname 454). Generally speaking, it is not known a priori whether a legitimate securekey is being used and therefore the result of the decryption will be data (denoted 492) that only appears to specify a transaction indicia and data (denoted 494) that only appears to specify credit account information. Further authentication is thus required.

Accordingly, at step 630, the data center 122 forwards the key ID, as well as the data 492 that appears to specify a transaction indicia and the data 494 that appears to specify credit account information to the authentication entity 306 via the link 314. In addition, the data center 122 forwards the transaction confirmation indicia 670 and the decryption parameters 210* to the authentication entity 306 via the link 314. The remainder of the authentication process is detailed as follows.

At step 632, the authentication entity 306 verifies its database 36 of pending transaction indicia (and associated key IDs) to see whether any of the pending transaction indicia is associated with the received key ID. In the present example, the transaction indicia 470 was indeed pending and therefore if the data 492 that appears to specify a transaction indicia does correspond to the transaction indicia 470, then authenticity of the prospective transaction will have been virtually confirmed, save one final step, which is to match the transaction confirmation indicia 670 received the from data center 122 with information that is expected to be received from the customer's computer 106 via the merchant 104. For this purpose, the authentication entity 670 stores the transaction confirmation indicia 670 in the database 36, in association with the received key ID.

Attention is now drawn to step 634, which occurs shortly before, during or shortly after step 630, and which is characterized by the data center 122 encrypting the new encryption parameters 222, the new decryption parameters 222* as well as the transaction confirmation indicia 670 into a return information packet 680 that is forwarded to the securekey 108 via the consumer's computer 106. Encryption is performed using the current encryption parameters 210 stored in the field 320 of the record 318* indexed by the securekey 108.

At step 636, the return information packet 680 is decrypted by the securekey 108 using the current decryption parameters 210*. As a result of decryption of the information packet 680, the securekey 108 obtains the new encryption parameters 222, the new decryption parameters 222* and the transaction confirmation indicia 670. Still as part of step 636, the securekey 108 causes the current encryption parameters 210 to be placed into temporary storage in the securekey memory 110. The securekey 108 then proceeds to cause the current encryption parameters 210 and the current decryption parameters 210* to be replaced with the recently received new encryption parameters 222 and new decryption parameters 222*, respectively, in the securekey memory. 110.

At step 638, the securekey 108 re-encrypts the transaction confirmation indicia 670 with the immediately previous version of the encryption parameters 210, as held in temporary storage in the securekey memory 110. The result is another information packet 682, which is sent to the merchant's web server 126, accompanied by the (unencrypted) key ID corresponding to the securekey 108. At this stage, the immediately previous version of the encryption parameters 210, as held in temporary storage in the securekey memory 110, is no longer needed and can be deleted.

Upon receipt of the information packet 682 and the key ID, the merchant's web server 126 recognizes the key ID as pertaining to a communication destined for the authentication entity 306. Accordingly, the key ID and the information packet 682 are forwarded to the authentication entity 306 (via the gateway 308 if appropriate).

At step 640, the authentication entity 306 receives the key ID and the information packet 682 and, on the basis of the current decryption parameters 210* received from the data center 122 for the specific key ID (see step 630, above), decrypts the information packet 682. If the transaction is legitimate, the decrypting of the information packet 682 should yield the transaction confirmation indicia 670 that was forwarded by the data center 122. Otherwise, i.e., if there is a discrepancy, then it can be concluded that the securekey 108, which may have appeared to be in the loop traveled by the transaction indicia 470, was not in the path traveled by the transaction confirmation indicia 670.

Thus, it can be appreciated that the provision of two counter-circulating “loops”, each one involving encryption by the securekey 108, further enhances security against fraudulent electronic transactions.

Login Transaction

In the case of a login transaction, the first party 102 can be referred to as a “user” and the second party can be referred to as a “service provider”.

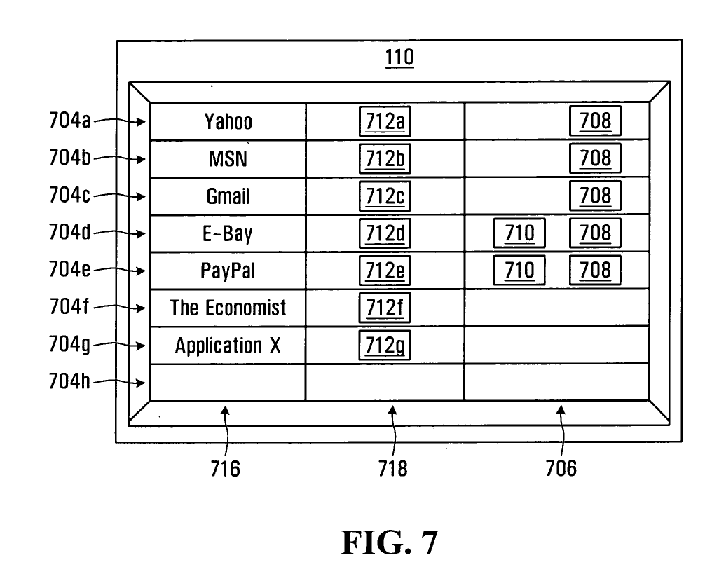

Further detail regarding the contents of the securekey memory 110 in the context of a login transaction is provided in the conceptual diagram of FIG. 7. Specifically, in this non-limiting example, a portion of the securekey memory 110 stores information regarding login accounts. This information can be visualized as a database of records 704a, . . . , 704h, each pertaining to a particular login account. In a particular configuration, each of the records 704a, . . . , 704h includes a “nickname” field 716, a data field 718 and a security field 706.

The contents of the nickname field 716 for a particular record is used to descriptively identify the record in question in a format that is convenient for the user. The contents of the nickname field 716 for a particular record includes a login account nickname. Illustrative but of course non-limiting examples of login account nicknames include “Yahoo”, “MSN”, “Gmail”, which are meant to represent login accounts with various email providers, as well as “E-bay” and “Paypal”, which are meant to represent login accounts with various shopping services, “The Economist”, which represents a login account for an on-line magazine, and “Application X”, which represents a login account for a particular software application (such as Microsoft Windows, for example).

The data field 718 for a particular record contains information regarding the record in question, in a format that is useful to the service provider. The contents of the data field 718 for a particular record 702a, . . . , 702h includes login account information, in this case denoted 712a, . . . , 712h. For example, the login account information for a record identified by the login account nickname “Yahoo” may include a username and a password that would be required for allowing access to a particular email account on yahoo.com.

Each record is additionally associated with a security field 706. For certain records associated with a relatively “low” security requirement (e.g., records 702f and 702g, pertaining to an on-line magazine subscription and a software application, respectively), the security field 706 may be blank, in other words, the contents of the nickname field 716 and of the data field 718 are freely accessible to an external requestor.

For certain other records associated with an “intermediate” security requirement (e.g., records 702a, 702b and 702c, pertaining to various email accounts), the security field 718 may specify a password 708 that needs to be entered before the contents of the nickname field 716 and of the data field 718 are released to an external requestor.

Finally, for still other records associated with a relatively “high” security requirement (e.g., records 702d and 702e, pertaining to shopping services), the security field 718 may specify both a password 708 and encryption parameters 710, which are used to encrypt the contents of the respective data field 718 before such contents are released by the securekey 108 via the input/output interface 114.

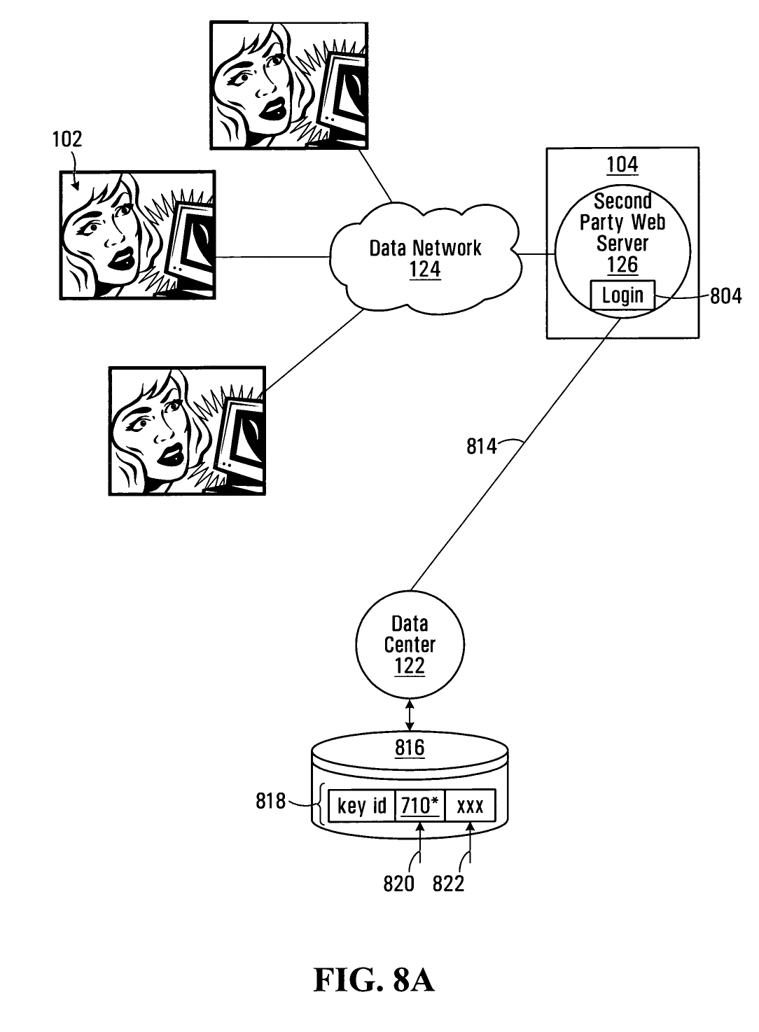

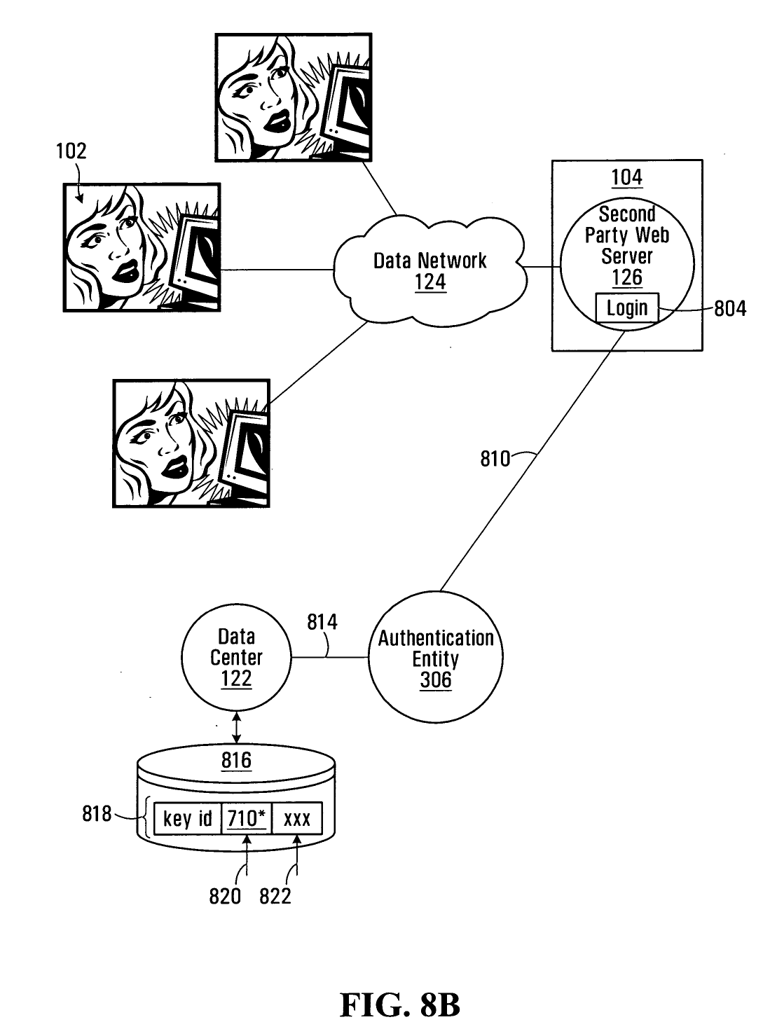

Turning now to FIGS. 8A and 8B, there is shown a service provider 104 that provides a login account for the user 102 as well as other users over the data network 124. Specifically, in the case of the user 102, the service provider 104 operates a web server 126 that runs a login application 804 which interacts with the browser 118 running on the user's computer 106. When the user 102 desires to access his or her account, the login application 804 prompts the user 102 via the browser 118.

In order to authenticate the electronic transaction consisting of a login request by the user 102, and as will be described in further detail herein below, the web server 126 of the service provider 104 communicates with an authentication entity 806. For “larger” service providers (FIG. 8A), the authentication entity 806 may be part of the service provider's infrastructure, which comprises the web server 126 and possibly other equipment. For “smaller” service providers (FIG. 8B), the authentication entity 806 may be a separate entity to which the service provider 104 connects via a secure or unsecure link 810, possibly via the data network 124.

The authentication entity 806 is connected to the data center 122 by a link 814 that is considered secure. The data center 122 maintains information regarding the various securekeys (including securekey 108 belonging to the user 102) and, by extension, the various users. Specifically, the data center 122 maintains a database 816 of records 818, where each record 818 corresponds to a different securekey and is indexed by the corresponding securekey's key ID.

Specifically, the record 818 corresponding to the securekey 108 comprises a field 820 which contains decryption parameters 710* that are needed to decrypt information encrypted by the securekey 108 using the aforementioned encryption parameters 710. In addition, the record 818 corresponding to the securekey 108 may comprise another field 822 which contains some or all of the login account information for the user 102 associated with the securekey 108. This may be advantageous in case the securekey 108 is lost or damaged, and a new one needs to be sent to the user 102.

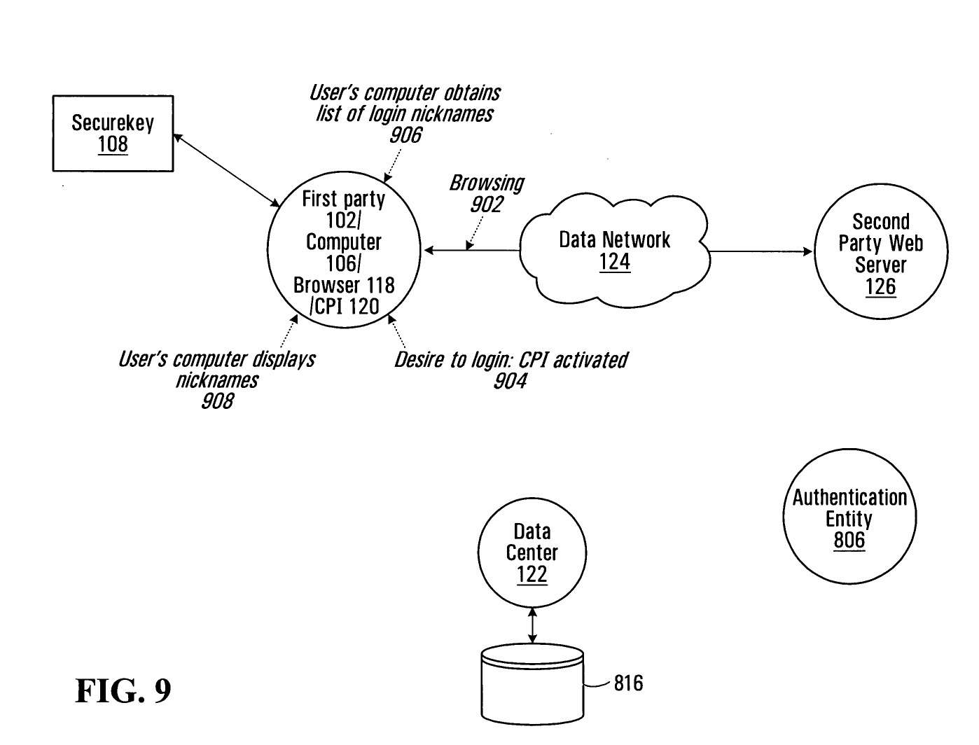

Various steps in an example process for securing a transaction are now described with reference to FIGS. 9, 10 and 11A-11C. Specifically, with reference to FIG. 9, at step 902, the user 102 uses the browser 118 on the user's computer 106 to browse the data network 124. It is recalled that the browser 118 is equipped with the aforementioned client plug-in (CPI) 120 which gives the browser 118 additional functionality. For the purposes of illustration, it is also assumed that the user 102 is “legitimate”, i.e., is connected to the previously described securekey 108, which is presumed to be registered with the data center 122.

At step 904, the user 102 decides to effect an electronic transaction (i.e., a login to a specific account) and thus accesses the login application 804 running on the service provider's web server 126. As the transaction has not yet actually been completed, it can be referred to as a prospective transaction. Access to the login application 804 activates the CPI 120, which has the following effect. Specifically, at step 906, the CPI 120 queries the securekey 108 to obtain the list of login account nicknames (i.e., the contents of the nickname field 716 of each record 704a, . . . , 704h) stored in the securekey memory 110.

As previously mentioned, access to the some of the contents of the securekey memory 110 may be restricted, and for example a password 708 may need to be entered by the user 102 in order for such contents (in this case, certain ones of the login account nicknames) to be released. In the above described example, if the password 708 is not provided, then only the login account nicknames “The Economist” and “Application X” will be available to the CPI 120. However, assuming that the password 708 is provided, the CPI 120 obtains the entire set of login account nicknames contained in the nickname field 716 of the various records 704a, . . . , 704h in the securekey memory 110. At step 908, the CPI 120 renders the nicknames available for selection by the user 102.

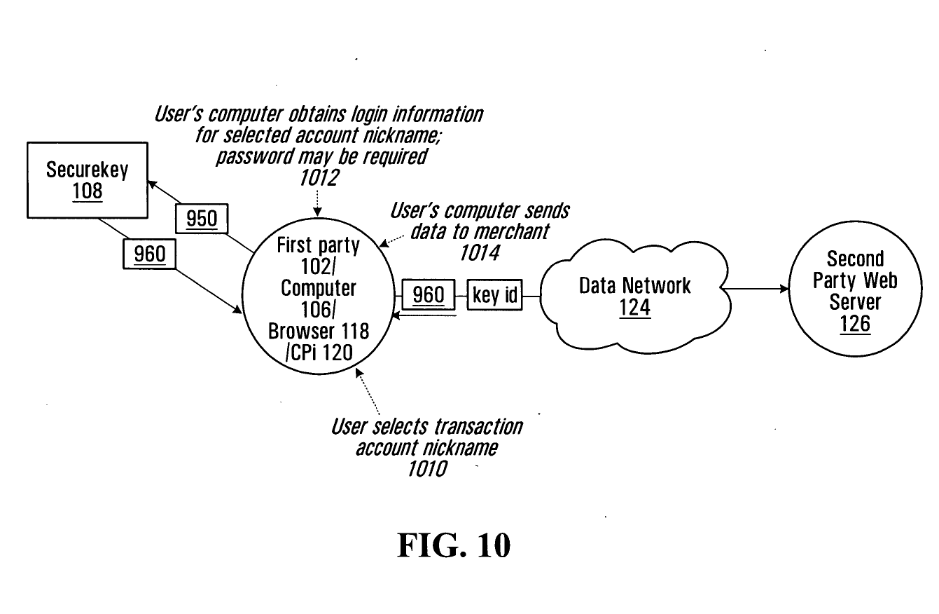

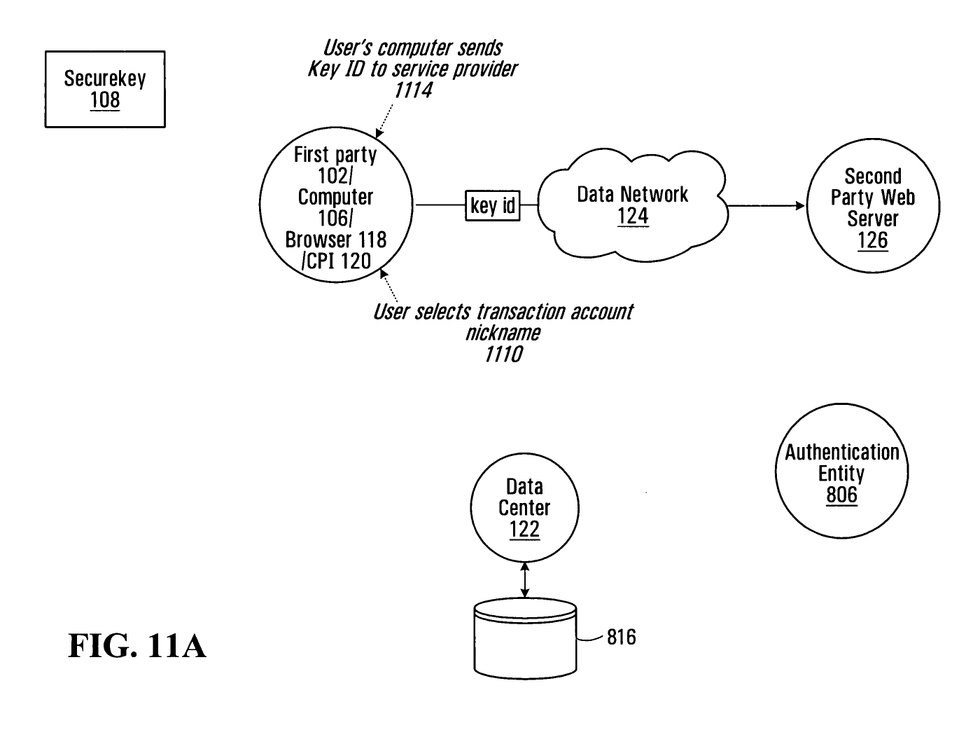

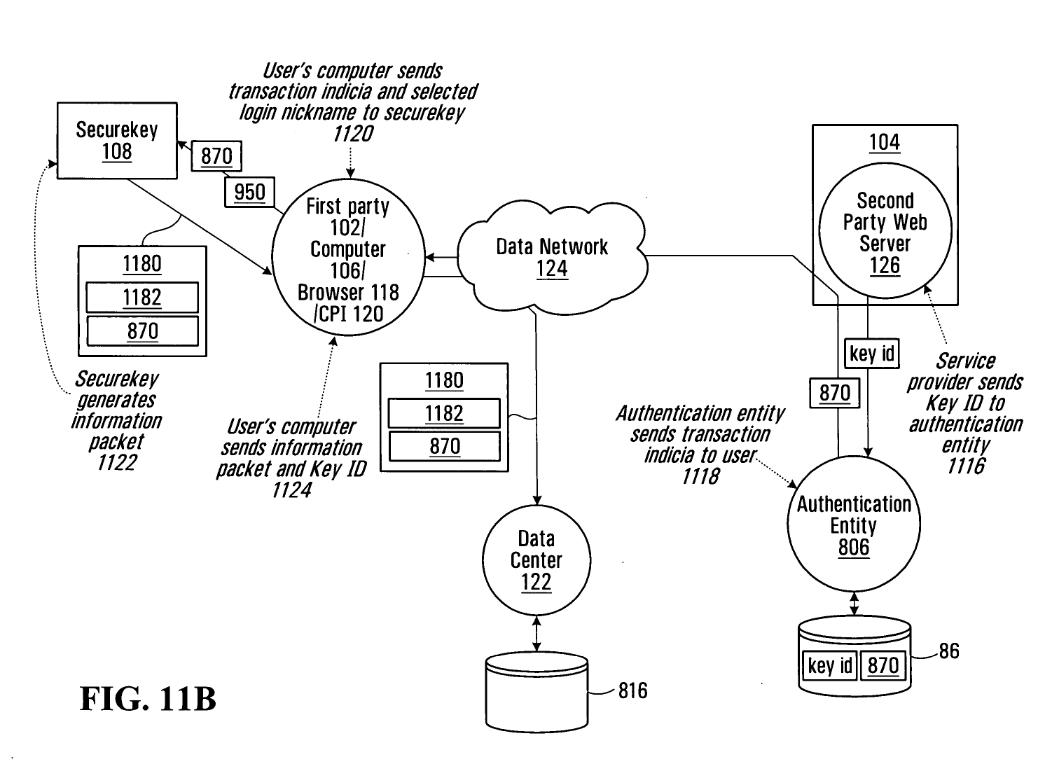

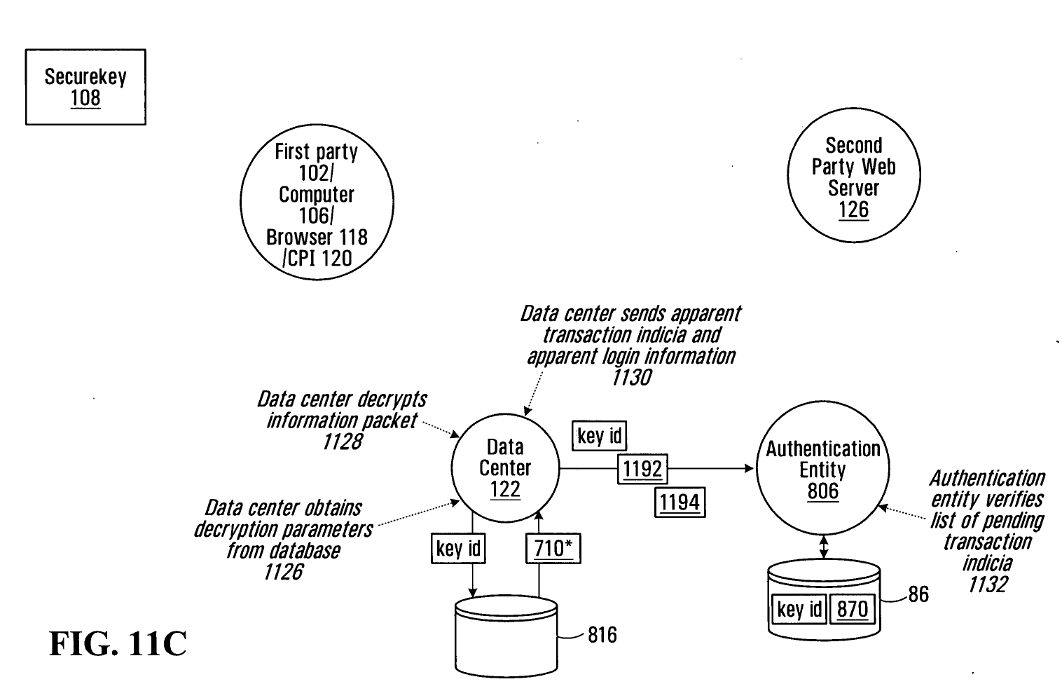

Depending on the type of login account, the user 102 may select one of the login accounts for which the security requirement does not specify any encryption parameters. This scenario is dealt with in FIG. 10, whereas the scenario in which the user 102 selects one of the login accounts for which the security requirement does specify encryption parameters 710 is dealt with in FIGS. 11A-11C.

With reference therefore to FIG. 10, at step 1010, the user 102 selects one of the login account nicknames corresponding to a login account that the user 102 wishes to use for the current prospective transaction. The selected login account nickname will hereinafter be referred to as the “transaction account nickname” and is denoted 950. At step 1012, the computer 106 provides the login account nickname 950 to the securekey 108 via the input/output interface 116. The securekey 108 responds by returning the contents of the data field 718 of the record identified by the login account nickname 950 (which is hereinafter referred to as “login account data” and denoted by the reference numeral 960). At step 1014, the login account data 960 is forwarded by the user's computer 106 to the web server 126 over the data network 124, thereby completing the electronic transaction, which exchanges login credentials for access to an account.

With reference to FIG. 11A, at step 1110, the user 102 selects one of the login account nicknames corresponding to a login account that the user 102 wishes to use for the current prospective transaction. The selected login account nickname will hereinafter be referred to as the “transaction account nickname” and continues to be denoted 950 (although not shown in FIG. 11A). However, because the record identified by the transaction account nickname 950 is associated with the encryption parameters 710, the transaction account nickname 950 is not submitted to the securekey 108 but instead is retained by the computer 106 for later use. At step 1114, the key ID of the securekey 108 (which is learned by the CPI 120 through its connection to the securekey 108) is forwarded by the user's computer 106 to the web server 126 over the data network 124.

With reference to FIG. 11B, at step 1116, the web server 126 forwards the received key ID to the authentication entity 806 for authentication of the prospective transaction. Through receipt of the key ID, the authentication entity 806 learns that there is a user, in this case the user 102, who is effecting a prospective transaction and is claiming to be using a securekey, in this case the securekey 108 identified by the key ID. Since the authenticity of the user 102 is not yet known to the authentication entity 806, authentication of the user 102 is undertaken. To authenticate the user 102, the authentication entity 806 engages the user's securekey 108 in a test by providing test data to the user's computer 106. This test data is hereinafter referred to as “transaction indicia” 870, which is associated with the key ID and stored in a list or database 86 at the authentication entity 806. Accordingly, at step 1118, the authentication entity 1106 sends the transaction indicia 870 to the user's computer 106 via the data network 124. In a non-limiting example, the transaction indicia 870 is an alphanumeric code.

At step 1120, the CPI 120 running on the user's computer 106 sends the transaction indicia 870 as well as the previously retained transaction account nickname 950 to the securekey 108. The securekey 108 locates the login account information in the data field 718 of the record identified by the transaction account nickname 950. This login account information is denoted by the reference numeral 1182. In addition, the securekey 108 determines that there is a requirement to encrypt the login account information 1182 using the encryption parameters 710 before releasing it to the requestor (namely, the CPI 120). Accordingly, at step 1122, the securekey 108 uses the encryption parameters 710 to encrypt both the login account information 1182 and the transaction indicia 870. The encrypted login account information and encrypted transaction indicia are placed together in an information packet 1180 which, at step 1124, is bundled together with the key ID (which is not encrypted using the encryption parameters 710) and sent by the user's computer 106 to the data center 122 via the data network 124.

With reference now to FIG. 11C, the data center 122 receives the information packet 1180 and the key ID over the data network 124 and uses the key ID as an index into the database 816 in order to identify a corresponding one of the records 818 that is indexed by the received key ID (i.e., the key ID of the securekey 108). At step 1126, the data center 122 identifies the decryption parameters 710* contained in the corresponding one of the records 818. It is recalled that if the encryption process is symmetric, then the decryption parameters 710* will be identical to the encryption parameters 710.

At step 1128, the data center 122 attempts decryption of the information packet 1180 using the decryption parameters 710* found in the database 816. In the case where a legitimate securekey 108 was employed, decryption of the information packet 1180 will be successful and the result of the decryption will be the transaction indicia 870 and login account information (which is the login account information corresponding to the transaction account nickname 950). Generally speaking, it is not known a priori whether a legitimate securekey is being used and therefore the result of the decryption will be data (denoted 1192) that only appears to specify a transaction indicia and data (denoted 1194) that only appears to specify login account information. Further authentication is thus required.

Accordingly, at step 1130, the data center 122 forwards the key ID, as well as the data 1192 that appears to specify a transaction indicia and the data 1194 that appears to specify login account information to the authentication entity 806 via the link 814. At step 1132, the authentication entity 806 verifies its database 86 of pending transaction indicia (and associated key IDs) to see whether any of the pending transaction indicia is associated with the received key ID. In the present example, the transaction indicia 870 was indeed pending and therefore if the data 1192 that appears to specify a transaction indicia does correspond to the transaction indicia 870, then authenticity of the prospective transaction will have been confirmed. In other words, it will have been confirmed that the data 1194, which heretofore only appeared to specify login account information, does indeed specify login account information for a login account that the user 102 genuinely wishes to use for the current prospective transaction. It is recalled that in the present example, this login account information was referred to by the reference numeral 1182.

However, if the data 1192 that appeared to specify a transaction indicia does not correspond to the transaction indicia 870 (or any other pending transaction indicia for the securekey corresponding to the key ID), then the prospective transaction will not have been successfully authenticated. In this case, action can be taken by the authentication entity 806, such as signaling to the service provider 104 that the prospective transaction may be fraudulent.

Those skilled in the art should be understood that the enhancements described above when discussing the example of a commercial transaction also apply to the case of a login transaction in order to provide added layers of security.

Changes to the Data Stored by the Securekey 108

The securekey 108 can be issued to the first party 102 by an issuing entity, and can be delivered to the first party 102 over a wide variety of channels (e.g., by direct mail, by having the first party 102 visit their usual branch, by purchasing the securekey 108 at a kiosk, etc.)

There are also various ways in which the securekey memory 110 can be configured to store the relevant information pertaining to the first party 102. For example, the data to be stored in the securekey memory 110 can be supplied to the issuing entity by the first party 102 in an initial registration phase. In another embodiment, the first party 102 connects the securekey 108 to the computer 106 and then accesses the data center 122 over the data network 124, whereby the data center 122 securely downloads the relevant information into the securekey memory 110.

The latter technique can also be employed to update the securekey memory 110 in the event the first party 102 wishes to change the information stored therein (e.g., to change the data field or nickname field of a particular record, to add a record, to delete a record, etc.) As an alternative, which may be less economical, a new securekey 108 can be delivered to the first party 102, reflecting the changes to the data stored in the securekey memory 110.

It should also be appreciated that when initially using the securekey 108, the encryption parameters 210 used for the very first transaction can be pre-programmed by the issuing entity. Alternatively, a seed supplied by the issuing entity (e.g., over the data network 124) could be provided to trigger generation of the first set of encryption parameters 210 by the securekey processor 112.

It should further be appreciated that while reference has been made to the CPI 120 as a software plug-in, it is nevertheless within the scope of the present invention to implement the functionality of the CPI 120 using other functional constructs, such as integrating the CPI 120 with the browser, providing an independently launchable application, utilizing a web-based executable, etc.

Those skilled in the art will further appreciate that the functionality of various elements described above may be implemented as pre-programmed hardware or firmware elements (e.g., application specific integrated circuits (ASICs), electrically erasable programmable read-only memories (EEPROMs), etc.), or other related components. In other embodiments, the desired functionality can be achieved by an arithmetic and logic unit (ALU) having access to a code memory (not shown) which stores program instructions for the operation of the ALU. The program instructions could be stored on a medium which is fixed, tangible and readable directly by a processor (e.g., removable diskette, CD-ROM, ROM, or fixed disk), or the program instructions could be stored remotely but transmittable to the processor via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

While specific embodiments of the present invention have been described and illustrated, it will be apparent to those skilled in the art that numerous modifications and variations can be made without departing from the scope of the invention as defined in the appended claims.

What is claimed is:

1. A method of securing a prospective electronic transaction between a first party and a second party, the first party using a client computer, the method comprising:
generating a transaction indicia for the electronic transaction;
sending the transaction indicia to the client computer, wherein receipt of the transaction indicia by the client computer causes encryption of the transaction indicia and account information associated with the first party into encrypted data;
responsive to receipt of the transaction indicia and the account information from a data center to which the client computer has communicated the encrypted data, completing the electronic transaction on a basis of the account information.

2. The method defined in claim 1, the electronic transaction being a commercial transaction, the first party being a consumer, the second party being a merchant.

3. The method defined in claim 1, the electronic transaction being a login transaction, the first party being a user, the second party being a service provider.

4. The method defined in claim 1, wherein said sending the transaction indicia to the client computer comprises sending the transaction indicia to the client computer via the second party.

5. The method defined in claim 1, wherein the client computer and the second party communicate over the Internet.

6. The method defined in claim 1, wherein said encryption of the transaction indicia and account information associated with the first party is performed by an portable memory device communicatively coupled to the client computer.

7. A method of securing a prospective electronic transaction between a first party and a second party, the first party using a client computer, the method comprising:
receiving encrypted data from the client computer, the encrypted data comprising (I) an encrypted version of a transaction indicia obtained by the client computer from an authentication entity and (II) an encrypted version of account information associated with the first party obtained from a portable memory device communicatively coupled to the client computer;
decrypting the encrypted data using decryption parameters to obtain the transaction indicia and the account information;
sending the transaction indicia and the account information to the authentication entity for completion of the electronic transaction on a basis of the account information.

8. The method defined in claim 7, further comprising consulting a database to obtain the decryption parameters.

9. The method defined in claim 8, further comprising receiving an identifier of the portable memory device in association with the encrypted data.

10. The method defined in claim 9, wherein the database is organized into records indexed by respective identifiers, wherein consulting the database to obtain the decryption parameters comprises providing the identifier of the portable memory device as an index to the database and obtaining the decryption parameters in response thereto.

11. The method defined in claim 7, further comprising:
generating a confirmation indicia for the electronic transaction;
sending the confirmation indicia to the client computer, wherein receipt of the confirmation indicia by the client computer causes encryption of the confirmation indicia into second encrypted data;
sending the confirmation indicia to the authentication entity for decryption at the authentication entity of the second encrypted data into decrypted data and comparison of the decrypted data with the confirmation indicia in order to confirm authenticity of the electronic transaction.

12. The method defined in claim 11, further comprising sending the decryption parameters to the authentication entity for said decryption of the second encrypted data.

13. The method defined in claim 7, wherein the portable memory device uses first encryption parameters to encrypt the transaction indicia and the account information, the method further comprising:
generating second encryption parameters for use by the client computer in encrypting a future transaction indicia and other account information that is also associated with the first party;
sending the second encryption parameters to the client computer.

14. The method defined in claim 7, the electronic transaction being a commercial transaction.

15. The method defined in claim 7, the electronic transaction being a login transaction.

16. A system for securing a prospective electronic transaction between a first party and a second party, the first party using a client computer, the system comprising:
an authentication entity adapted for:
generating a transaction indicia for the electronic transaction;
sending the transaction indicia to the client computer, wherein receipt of the transaction indicia by the client computer causes encryption of the transaction indicia and account information associated with the first party into encrypted data;
a data center adapted for:
receiving the encrypted data from the client computer;
decrypting the encrypted data to obtain the transaction indicia and the account information associated with the first party;
sending the transaction indicia and the account information to the authentication entity for completion of the electronic transaction on a basis of the account information.

17. The system defined in claim 16, further comprising a portable memory device communicatively coupled to the client computer, the portable memory device being adapted to perform said encryption of the transaction indicia and account information associated with the first party.

18. The system defined in claim 16, the authentication entity being integrated with the second party.

19. The system defined in claim 16, the authentication entity being connected to the second party via a gateway.

20. The system defined in claim 16, the authentication entity being connected to the second party over a public data network.

21. A portable memory device for facilitating on-line transactions performed via a computer running a browser, said portable memory device comprising:
a data storage medium for holding data indicative of account information;
a communication interface for allowing said portable memory device to establish a temporary data communication pathway with the computer to supply via the data communication pathway the account information for use by the browser in effecting an on-line transaction.

22. A portable memory device as defined in claim 21, wherein said communication interface is adapted for establishing a wireless connection with the computer.

23. A portable memory device as defined in claim 21, wherein said communication interface includes a connector for establishing an electrical connection with the computer.

24. A portable memory device as defined in claim 23, wherein said communication interface includes a USB connector.

25. A portable memory device as defined in claim 24, wherein the account information pertains to a credit account.

26. A portable memory device as defined in claim 24, wherein the account information pertains to a login account.

27. A portable memory device as defined in claim 21, further comprising a processing unit in communication with said data storage medium for managing a transfer of data from said data storage medium to the computer via the data communication pathway.

28. A portable memory device as defined in claim 27, wherein said processing unit is capable of performing a user authentication process.

29. A portable memory device as defined in claim 28, wherein the user authentication process includes processing user authentication information supplied by a user.

30. A portable memory device as defined in claim 29, wherein the user authentication information is entered at the computer and communicated to said processing unit via the data communication pathway.

31. A portable memory device as defined in claim 30, wherein said processing unit is adapted to preclude transmission of the account information on the data communication pathway if the user authentication process fails.

32. A device for securing electronic transactions between a first party and a second party, the first party using a client computer, the device comprising:
an input/output interface for interfacing with the client computer;
a memory storing at least one account information record for the first party, each of the account information record storing account information and being accessible by a respective identifier;
a processing unit having encryption functionality and adapted to interact with a browser executing on the client computer, the processing unit being responsive to receipt of a particular identifier to encrypt the account information in the account information record corresponding to the particular identifier into encrypted data and provide the encrypted data to the client computer via the input/output interface.

33. Computer-readable media tangibly embodying an application program executable by a client computer to perform a method of securing electronic transactions between the client computer and a server, the application program comprising:
computer-readable program code means for being attentive to receipt of an identification of a desired account to be used in an electronic transaction;
computer-readable program code means for signaling to the server a desire to effect the electronic transaction;
computer-readable program code means for being attentive to receipt from an authentication entity of a transaction indicia for the electronic transaction;
computer-readable program code means for supplying the transaction indicia and the identification of the desired account to a device communicatively coupled with the client computer;
computer-readable program code means for being attentive to receipt from the device of an information packet comprising an encrypted version of the transaction indicia and an encrypted version of account information associated with the desired account;
computer-readable program code means for releasing the information packet to a data center capable of decrypting the information packet and forwarding the transaction indicia and the account information to the authentication entity for completion of the electronic transaction.

34. Computer-readable media defined in claim 33, the application program further comprising:
computer-readable program code means for being attentive to receipt of an identification of a desired shipping or billing address to be used in the electronic transaction;
computer-readable program code means for supplying the identification of the desired shipping or billing address to the device;
computer-readable program code means for being attentive to receipt of address information associated with the desired shipping or billing address;
computer-readable program code means for releasing the address information to the server.
